(19) United States
(12) Patent Application Publication
(10) Pub. No.: US 2002/0046087 A1
(43) Pub. Date: Apr. 18, 2002

(54) Method of drawing attention to advertisements

(76) Inventor: John Hey, Weston, MA (US)

Correspondence Address: BRIAN M. DINGMAN, MIRICK, O'CONNELL, DEMALLIE & LOUGEE, LLP, 100 FRONT STREET, WORCESTER, MA, 01608, US

(21) Appl. No.: 09/682,590

(22) Filed: Sep. 25, 2001

Related U.S. Application Data
(60) Provisional application No. 60/255,793, filed on Dec. 18, 2000.

(51) Int. Cl. G06F 17/60; G09B 3/00; G09B 7/00

(52) U.S. Cl. 705/14; 434/322

(57) ABSTRACT

A method for compelling that attention be paid to an advertisement within a sufficiently interactive environment, comprising presenting an ad prior to the delivery of material desired by a viewer, and requiring that the viewer answer a question about that ad before receiving the desired material.

### CROSS REFERENCE TO RELATED APPLICATION

This application claims benefit of Provisional application, serial No. 60/255,793 filed on Dec. 18, 2000.

### FIELD OF THE INVENTION

The present invention relates to means of motivating viewers of interactive media (e.g., Internet web sites, interactive TV) to read an advertisement placed proximate or within the media material being viewed, and more particularly, to means of verifying that the viewer has actually read (and understood) the advertisement. Still more particularly, the present invention relates to techniques for exploiting the certainty that a particular advertisement has been read by a particular viewer.

### BACKGROUND OF THE INVENTION

Modern advertising has become notorious for intruding upon every available square inch of view space and clamoring for public attention. Meanwhile, of course, the very public whom it targets has become increasingly adept at generally ignoring advertising.

A clear example of this ongoing conflict is the tactical arsenal used by TV advertisers trying to capture viewers' always elusive attention. Accordingly, commercials have become more elaborate, outrageous, loud, and (especially) numerous. They're often inserted into TV shows at unpredictable points, to discourage scheduled “kitchen breaks”. One technique even contrives to hold the vendor's product lengthily in prominent camera-view, so it will be visible even to VCR viewers who fast-forward through the commercial. (More evidence of this battle's intensity is the public's willingness to spend money for the sparser advertisements of pay-TV.)

A similarly vigorous war takes place on the Internet, where web pages often teem with advertisements, each waving frantically to catch the eye of the all-too-jaded user. Their attention-seeking gimmicks abound: animation, sound, “pop-under” windows, etc., and even mimicry of system alarms. But the experienced web-user learns to ignore (or to quickly dispose of) such stratagems as soon as they become familiar.

This is particularly troublesome to a typically “successful” web site, which delivers content its users value, but which must also derive significant revenue from advertisers. The proliferation of increasingly ineffective advertisements lowers disastrously the price-per-impression that web advertising is able to command, because each “impression” is of such dubious quality. (Some advertisers elect to pay for “click-through”, rather than for mere impressions. But that high threshold admits only the rare user who: 1) happens to spy the ad among its many brethren, 2) elects to read it, and 3) likes it enough to reach for the mouse. Furthermore, click-through aren't an appropriate response for some ads, e.g., “brand-awareness” ads.)

As an alternative to revenue based on advertising, a web site may consider charging its users a subscription fee. However, such fees remains contrary to long-standing Internet culture, wherein usage of web sites is predominantly free both by habit and by principle.

Still, savvy users do grasp the economic reality that their favorite web site requires funding in order to thrive, and so accept advertising as a necessary evil. (To wit, many web sites remain popular despite their plethora of banner and pop-up ads; some web-access providers even conscript a fixed area of the user's screen as a permanent “billboard”.)

The public's skill at ignoring ads engenders not only their rampant proliferation, but also (ironically) to the public's tolerance of that proliferation. An unpleasant side-effect is that actual content occupies an ever-decreasing portion of broadcast media presentations.

In a more systematic view, ignored ads (which the advertising industry accepts as endemic to its business) comprise a substantial waste of “bandwidth”. Such waste predominates because, viewed as a communication exercise, an ad is merely an unreliable message. I.e., the message, though nominally delivered to its intended recipient, may never be seen, and, even if it is, may never be read or understood.

### SUMMARY OF THE INVENTION

Taking the above into consideration, it is an object of the present invention to provide means of motivating the end-user of a sufficiently interactive medium (e.g., a visitor to a web site) to read an ad presented in conjunction with content the user desires to receive. A further object of the present invention is to provide means of confirming that a particular user has read a particular ad. Still a further object of the present invention is to enable a content provider (e.g., a web site) to charge for content, in a manner users deem acceptable. Yet a further object of the present invention is to allow a provider to be credibly informed that a particular user has read a particular ad, so that the provider may accordingly modify further presentations to that user. And a still further object of the present invention is to use efficiently an interactive medium's “advertising bandwidth”. (Such “bandwidth” comprises both available ad-space and users' tolerance and retention.)

In one preferred embodiment, for each web-site ad using the present invention, the ad's creator also creates for that ad a simple multiple-choice question whose answer can be found in the ad's content. (Ideally but not necessarily, the question addresses some fact that the advertiser particularly wishes to convey, i.e., the ad's principal “thrust”.) A visitor normally proceeds sequentially through the web site's pages by clicking a simple “next”-button on each successive page. But, on a page where an ad appears, the “next”-button is replaced by the multiple-choice question associated with the ad. Because the correct answer is also the sole link to the next page, the visitor can proceed only by clicking that answer. Thus, the accessibility of further material within the web site is made contingent upon the viewer's reading such ads as they occur, enabling him to correctly answer the associated questions.

The above and other objects, contexts, features, and advantages of the present invention will become apparent from the following description, taken in conjunction with the accompanying drawings which illustrate preferred embodiments of the present invention by way of example.

### BRIEF DESCRIPTION OF DRAWINGS

FIG. 1 shows a typical web page.

FIG. 2 shows the web page of FIG. 1, now including an advertisement and question according to the present invention.

FIG. 3 shows the web page that succeeds FIG. 2's web page, resulting from a correct answer to the question posed in FIG. 2.

FIG. 4 shows a modified re-presentation of FIG. 2's web page, resulting from an incorrect answer to the question posed in FIG. 2.

FIG. 5 diagrams the display of a novel's chapters, with advertisements inserted according to the present invention.

FIG. 6 shows the web page of FIG. 2, but with the question serving directly as the link to exit the web page.

FIG. 7 shows two web pages, illustrating how the question can be physically separated from its associated advertisement.

FIG. 8 diagrams an embodiment that presents continuous material incorporating advertisements and their associated questions.

FIG. 9 diagrams an embodiment that grants the viewer a simple once-only permission, to be granted only after the viewer reads an advertisement.

### DETAILED DESCRIPTION

Certain preferred embodiments of the present invention will now be described in conjunction with the accompanying drawings.

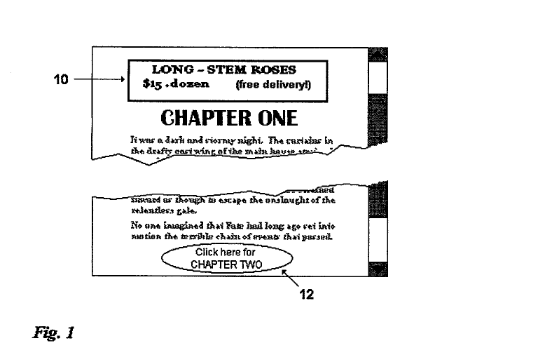

To introduce a first preferred embodiment, consider a straightforward web site that presents (for example) a 10-chapter novel. Some of the web pages display at the top a banner ad 10, FIG. 1, followed by a chapter of the novel, followed by a “next”-button 12 that links to the succeeding chapter's web page. Obviously, this typical advertising practice allows visitors to read freely the entire novel despite taking only minimal (if indeed any) true notice of what each ad actually says.

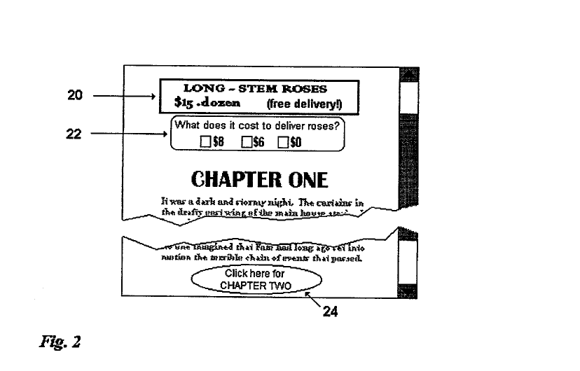

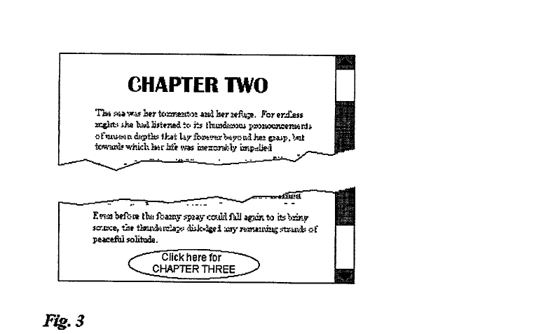

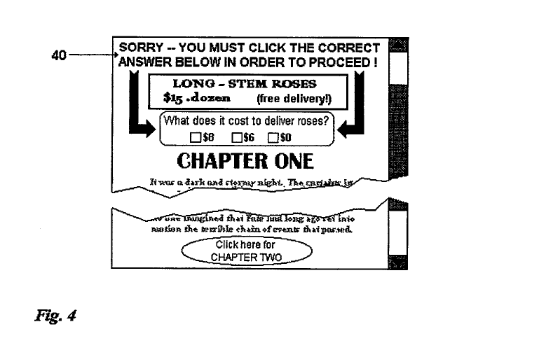

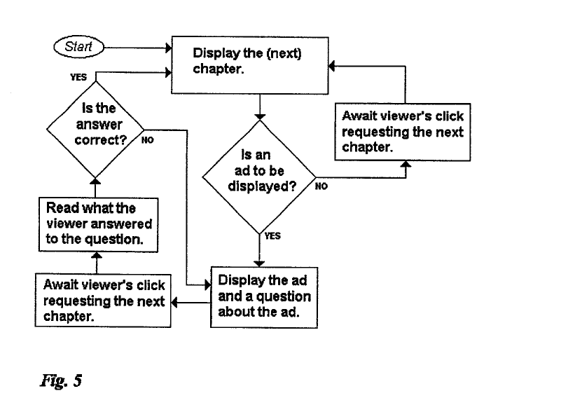

The first preferred embodiment affixes to the banner ad 20, FIG. 2, a multiple-choice question 22 about some portion of the ad's content. The web page is internally coded so that the visitor's response (if any) to the question is embedded within his request for the next page. (Such a request is sent to the web site when the visitor clicks the “next”-button 24.) If the visitor's response to the question is correct, the next chapter's web page FIG. 3 is delivered to him. If, however, the visitor's response is incorrect, a repeat of the current web page FIG. 4 is instead delivered, now including a more emphatic plea 40 for the correct answer. The overall event-sequence of the first preferred embodiment is diagrammed in FIG. 5.

(Note that, rather than a single ad and question, multiple ads and questions may be used. Note also that a typical web environment may allow an alternative flow of control. E.g., a web page can be coded so that the visitor's web browser itself detects and rejects an incorrect visitor-response to the ad's question. Or, a browser “plug-in” could verify and service both correct and incorrect responses locally, i.e., on the visitor's computer, without sending requests to the web site's server.)

The question, which can address any aspects of the ad whatsoever, may focus especially upon those the ad particularly seeks to convey, e.g., a sale-price or other competitive advantage of the advertised product.

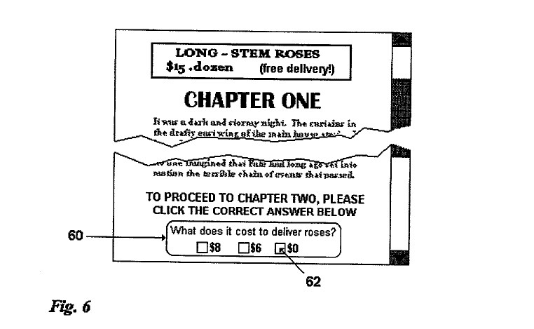

In a variation (FIG. 6) of the first preferred embodiment, the “next”-button has been entirely replaced with the multiple-choice question 60. Correspondingly, the correct answer 62 has been coded as a direct link to the succeeding chapter of material.

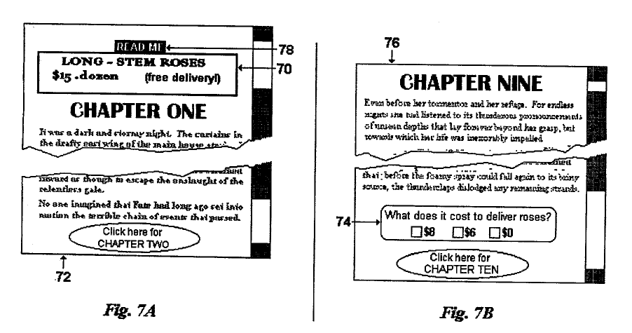

In the foregoing illustrations (FIGS. 2 and 6), the multiple-choice question appears on the same web page as its associated ad. However, a stronger ad-impression could be enforced by (for example) delaying the question until several pages later than the ad itself, thereby forcing the visitor either to memorize or to re-visit the ad before proceeding beyond the page containing the question. In FIG. 7A, the page 72 containing the ad 70 does not contain the ad's associated question. Instead, a much later page 76, FIG. 7B, contains that question. (Note that a signal 78 can warn the visitor of the ad's special status, so that he can know to pay it particular attention at first reading.)

Because an ad using the present invention garners an inherently greater measure of viewer attention than ordinary banner ads, it may be billed to advertisers at a premium rate.

(Although embodiments described here use “banner” ads, the methodology applies to any advertisement upon whose content a viewer may be directly questioned.)

An extension of the first preferred embodiment presents ads and their associated questions to each viewer at regular time-intervals, e.g., weekly. The viewer's correct responses comprise a “subscription fee” for continued access to the ongoing service offered by the web site (e.g., such services as news, arts and TV listings, reference works, searches).

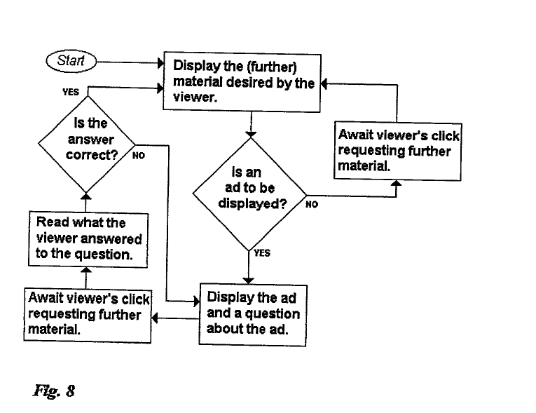

A second preferred embodiment straightforwardly incorporates the present invention into a stream of continuous material presented to a viewer via an interactive medium. Examples of such streams might include novels being read electronically (e.g., “eBooks”), or video games or movies, or movies being watched on a DVD player. At one or more points during the stream of material, an ad and its associated question are presented. The viewer is granted access to further material only when he has answered the question correctly. This dependency is diagrammed in FIG. 8.

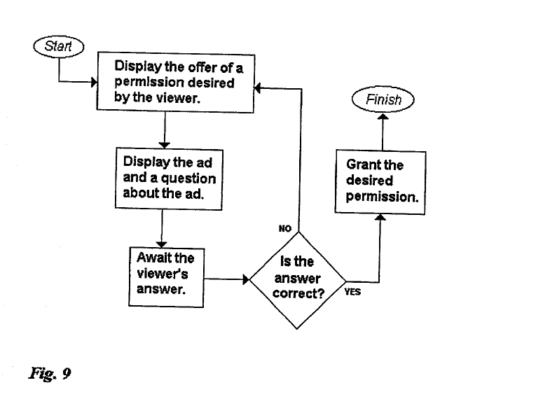

A third preferred embodiment incorporates the present invention into the minimized context of a single viewer-interaction. Within a sufficiently interactive environment, a viewer desires to be granted a simple permission of some sort, but is first obliged to read one or more advertisements. For example, a web site user might seek to download a piece of software from the site, but is first obliged to read an advertisement posted on the site. As a further example, an interactive-TV viewer might seek permission to watch or download an upcoming program or movie, but is compelled to view one or more advertisements beforehand. FIG. 9 diagrams an implementation of this simple embodiment. (Note that the diagrammed implementation is particularly “forgiving”, allowing the viewer repeated tries at answering the question correctly. Notwithstanding, less user-friendly implementations might impose a time-delay or other penalty for a wrong answer.)

Note that in some environments (such as the client-server interactivity of web browsing) it's relatively easy to tally the number of correct responses to each ad. Counting such responses reflects an ad's actual “impressions” more accurately than simply counting the ad's “showings”.

Note also that an interactive ad-server may record that a given viewer has correctly responded to a given ad, and might later advise not to repeat that ad for that viewer. The present invention makes such “considerateness” practical because of its inherent assurance that the viewer has already fully assimilated the ad. (No such assurance obtains from merely “showing” the ad to the viewer.)

In a fourth preferred embodiment, shared tabulations are maintained which enable advertisement presenters (e.g., web sites) and advertisers to know which ads have already been successfully delivered to which viewers and by which presenters. (A delivery is deemed “successful” when the viewer responds correctly to the ad's associated question.) In an environment where such knowledge is available, an individual viewer may be generally credited for his “consumption” of an ad, regardless of where it occurs. (Marketing-schemes for redeeming such credits are, of course, as numerous as marketers.) Likewise, presenters may race each other to introduce each new ad to each viewer, and may be compensated by advertisers according to their success.

1. A method for compelling a viewer within an interactive environment to read an advertisement, comprising:
presenting the advertisement to the viewer;
presenting, proximate the advertisement, at least one question whose answer can be gotten by reading the advertisement; and
requiring the viewer to answer correctly at least one such question in order to proceed.

2. The method of claim 1, in which the advertisement accompanies a sequence of material being presented to the viewer:
in which the advertisement is presented prior to delivering at least some of the desired material; and
in which the viewer is required to answer the question correctly in order to receive at least some of the desired material.

3. The method of claim 1, in which the question confirms directly the viewer's grasp of at least one principal fact the advertisement seeks to convey.

4. The method of claim 1, in which the advertisement is charged at a premium over ordinary advertisements.

5. The method of claim 1, in which the advertisement and question are presented at widely separate locations within the material.

6. The method of claim 1, in which the answer by the viewer comprises payment by the viewer for material yet to be delivered to the viewer.

7. The method of claim 1, in which the answer by the viewer comprises payment by the viewer for continued sequential access of material in an interactive environment.

8. The method of claim 1, in which the answer by the viewer comprises payment by the viewer for play of a game in an interactive environment.

9. The method of claim 1, in which the answer by the viewer comprises payment by the viewer for access to a restricted environment.

10. The method of claim 1, in which the answer by the viewer comprises payment by the viewer for a membership or similar affiliation.

11. The method of claim 1, in which the answer by the viewer comprises payment rendered by the viewer and deposited into an account credited to him.

12. The method of claim 1, in which the number of viewers correctly responding to the question is tabulated as a credible tally of the advertisement's impressions.

13. The method of claim 1, for which correctly answered advertisements are tabulated for each viewer, which tabulation is consulted to eliminate superfluous further presentations of advertisements to the viewer.

14. The method of claim 1, for which correctly answered advertisements are tabulated for each viewer, which tabulation is shared among two or more advertisement presenters.

15. The method of claim 14, in which the tabulation identifies also the presenter of each correctly answered advertisement.
